(19) United States
(12) Patent Application Publication
(10) Pub. No.: US 2007/0035553 A1
(43) Pub. Date: Feb. 15, 2007

(54) General framework for aligning textures

(75) Inventors: Denis Demandolx, Redmond, WA (US); Steven James White, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/202,610

(22) Filed: Aug. 12, 2005

(51) Int. Cl. G09G 5/00

(52) U.S. Cl. 345/582

(57) ABSTRACT

A method in image processing for aligning a texture from at least one input region to an output region is provided. In one embodiment, the method includes receiving information pertaining to at least one input, the information including a texture and corresponding texture coordinates, receiving information corresponding to the output region, utilizing the information pertaining to the input region and the output region to create a buffer having a plurality of vertices between the input and output. The method may further include mapping each of the texture coordinates to a vertex of the buffer such that the input aligns with the desired output. Various embodiments are disclosed having single or multiple inputs and buffers of various sizes. Systems for performing the described methods are also provided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Digitally represented still images are commonly used in the computer environment as graphics for applications software, games, and as digitally stored photographs that can be easily manipulated, printed and transmitted for commercial and entertainment purposes. As such, it is often necessary to be able to manipulate and easily modify such images, or portions thereof, through various editing capabilities, including the ability to rotate an image, crop it, and correct its brightness, contrast, and tint. Additional editing capabilities include the ability to cut portions out of an image, incorporate images into a collage, and many other special effects known to those of ordinary skill in the art.

It is through an imaging engine that the editing and reformatting of digital images is processed. The images are broken down to the individual pixel level for purposes such as those described above. In a demand driven imaging engine, image processing effects request inputs to render a region of pixels for proper alignment with the desired output. Each of these regions is called a requested rectangle. Typically input and output regions are identical in size and the rendering from input to output is 1:1. On occasion, however, image processing effects may modify these regions by, for instance, enlarging the regions, trimming the regions, or merging multiple input regions, in order to render the image in accordance with the desired output. The effects may also return a buffer of different size than requested. This can occur when the return buffer has a lot of data in areas beyond the image bounds, that is, data in the ‘abyss’. In this situation, an effect can trim the region to reduce the number of abyss pixels.

Image processing effects are charged with the proper handling of input and output alignment. However, depending on the desired form of the output, the input regions do not always line up with the desired output region coordinates. In these situations it is necessary to be able to properly align the input and output regions such that the desired image is obtained from the imaging engine.

### BRIEF SUMMARY

Embodiments of the present invention relate to texture alignment between input and output regions in image processing. Each input texture includes a bounding rectangle that defines the coordinates of the texture. These coordinates define where each texture is to be placed during image processing. “Texture alignment”, as the term is utilized herein, is a process for ensuring that all of the input textures are correctly placed according to their coordinates before image processing. When textures are properly aligned, they will appear visually similar in both the input and output regions. Texture alignment in accordance with embodiments of the present invention involves the use of a buffer between the input region and the output region. Texture coordinates derived from the input region are mapped to vertices of the buffer and such mappings are provided to a processing unit for processing. Once processed, the output region will include a texture, that is a result of the image processing effects applied on the textures of the input region that are correctly aligned with one another. Various embodiments of the buffer are described herein, selection of which may depend, for example, on the desired resolution level of the output and the quantity of inputs to the buffer.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a flow diagram showing a method for aligning a texture from an input region to an output region in accordance with an embodiment of the present invention;

FIG. 3 is a flow diagram showing a method for aligning multiple textures from a plurality of input regions to an output region in accordance with an embodiment of the present invention;

FIG. 4 is a schematic diagram illustrating the mapping of a texture from a single input region onto a buffer having a single quadrilateral in accordance with an embodiment of the present invention;

FIG. 5 is a schematic diagram illustrating the mapping of a plurality of input region textures onto a buffer having a single quadrilateral in accordance with an embodiment of the present invention; and

FIG. 6 is a schematic diagram illustrating the mapping of a plurality of input region textures onto a buffer having a plurality of quadrilaterals in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide a method in image processing for aligning a texture from at least one input region to an output region. In one embodiment, the method includes receiving information pertaining to the at least one input region, the information including a texture and corresponding texture coordinates, receiving information pertaining to the output region, utilizing the information pertaining to the input region and the information pertaining to the output region to create a buffer, the buffer having a plurality of vertices, and mapping each of the texture coordinates of the input region to a vertex of the buffer.

Embodiments of the present invention further provide methods in image processing for translating texture coordinates from at least one input region to a buffer associated with an output region for the purpose of aligning textures. In one embodiment, the method includes providing at least one set of u and v coordinates, each coordinate ranging between 0 and +1, and providing at least one set of x and y buffer coordinates, each coordinate typically ranging between −1 and +1, wherein the at least one set of buffer coordinates is associated with a vertex (Vᵢ) of the buffer. A method in accordance with this embodiment further includes mapping the at least one set of texture coordinates to the at least one set of buffer coordinates for the vertex (Vᵢ) as xᵢ, yᵢ, uᵢ, vᵢ.

Computer readable media having computer-useable instructions for performing the methods described herein, as well as computers programmed to perform the described methods, are also provided.

The present invention further provides systems in image processing for aligning a texture from an input region to an output region. In one embodiment, the system includes an input receiving component for receiving at least one input region, the at least one input region having a texture and corresponding texture coordinates, an output receiving component for receiving an output region, and a buffer creating component for creating a buffer having a plurality of vertices each of which is capable of having the texture coordinates of the at least one input region mapped thereto.

Having briefly described an overview of the present invention, an exemplary operating environment for the present invention is described below.

Exemplary Operating Environment

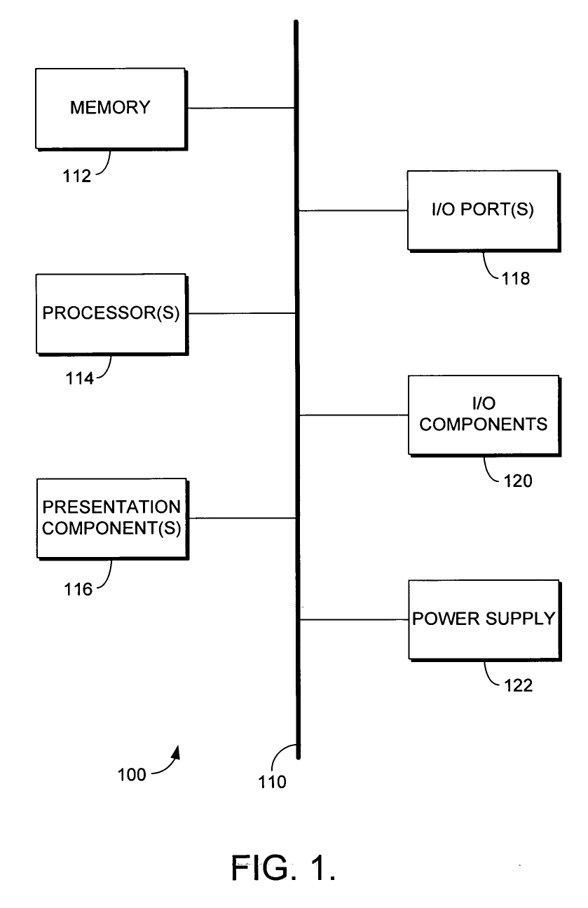

Referring to the drawings in general, and initially to FIG. 1 in particular, an exemplary operating environment for implementing the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, e.g., a personal data assistant or other handheld device. Generally, program modules including routines, programs, objects, components, data structures, and the like, refer to code that performs particular tasks or implements particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

Computing device 100 includes a bus 110 that directly or indirectly couples the following devices: memory 112, one or more processors 114, one or more presentation components 116, input/output (I/O) port(s) 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would be more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention.

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave, or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, and the like.

I/O port(s) 118 allow computing device 100 to be logically coupled to other devices including I/O components 120, some of which may be built in. Illustrative components include a microphone, joystick, game pad, satellite dish, scanner, printer, wireless device, and the like.

If desired, computing device 100 may further include a dedicated Graphics Processing Unit (GPU) (not shown) to accelerate computer graphic processing.

General Framework for Aligning Textures

As previously mentioned, embodiments of the present invention relate to a method in image processing for aligning a texture from an input region to an output region. For clarity purposes, it is best to identify some of the common terminology that will be discussed in greater detail with respect to embodiments of the present invention. An “input region”, as the term is utilized herein, is a section of image data having a texture and corresponding texture coordinates. A “requested rectangle”, as the term is utilized herein, is a region of image data that a user wants to render. The requested rectangle may be smaller in size than the input region if the user is interested in only rendering a particular portion of interest. A “buffer”, as the term is utilized herein, contains a plurality of vertices and is the location to which input texture coordinates are mapped before being directed to a processing unit. The “output region”, as the term is utilized herein, is the region of image data that will be rendered/generated by a processing unit, such as a graphical processing unit (GPU), for rendering. The output region is sized to include the input region(s), the requested rectangle, and the buffer. The processing unit is preferably a GPU. However, other processing units such as a Central Processing Unit (CPU) may be used as well. All such variations, and any combinations thereof, are contemplated to be within the scope of embodiments of the present invention.

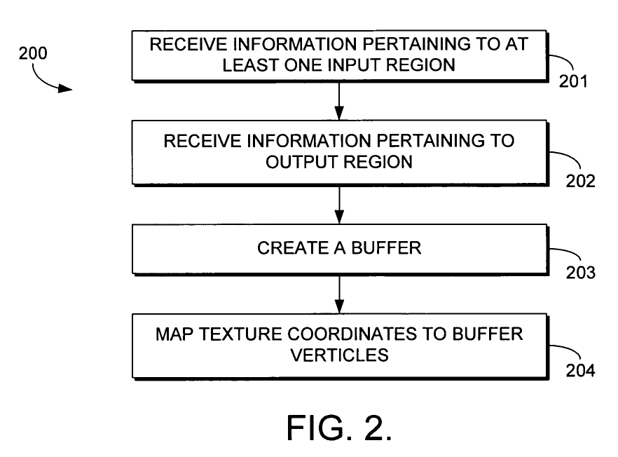

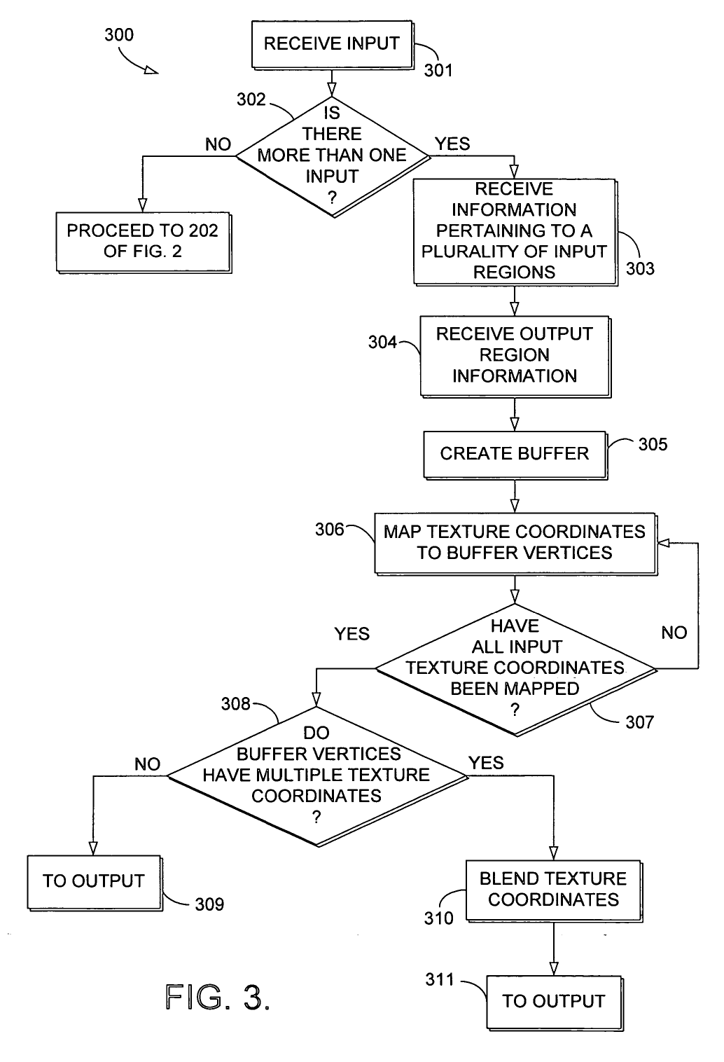

An exemplary method 200 for aligning a texture from an input region to an output region in accordance with an embodiment of the present invention is illustrated in the flow diagram of FIG. 2. Initially, as indicated at block 201, method 200 includes receiving information pertaining to at least one input region. In one embodiment, each input region includes a texture and corresponding texture coordinates associated therewith. The quantity of input regions received may vary. Method 200 further includes receiving information pertaining to the output region, as indicated at block 202. Such information may include, by way of example only and not limitation, information concerning output boundaries, image quality, etc.

Subsequently, utilizing the information pertaining to the input region and the output region, a buffer is created, as indicated at block 203. As more fully described below, the buffer includes a plurality of vertices. Next, each of the texture coordinates from the at least one input region are mapped to a vertex of the buffer via a mapping process that complies with the requirements of the output region. This is indicated at block 204. Note that in certain circumstances, for instance when there is no input to render at a particular location, there will be no input texture coordinates which correspond to certain coordinates of the buffer. This situation occurs where there is no input image to render at that location.

An exemplary method 300 in image processing for aligning the textures of input and output regions having more detail than the flow diagram of FIG. 2 is illustrated in FIG. 3. Initially, as indicated at block 301, information pertaining to at least one input region is received. Subsequently, a determination is made as to whether or not there is more than one input region to be considered by the imaging engine, as indicated at block 302. If it is determined that there is only one input region to be considered, then the method for aligning the input and output textures may proceed as previously defined with reference to blocks 202, 203, and 204 of FIG. 2.

However, if it is determined that there is more than one input region to consider, then information pertaining to each of the plurality of input regions is received, as indicated at block 303. Each input region for which information is received includes a texture and corresponding texture coordinates associated therewith. Subsequently, as indicated at block 304, information pertaining to the output region is received. Utilizing the received information, a buffer is subsequently created, as indicated at block 305, the buffer including a plurality of vertices and sized so as to set the limit as to what input regions (or portions thereof) will be considered for image processing.

Once the buffer has been created, the texture coordinates associated with each of the textures are mapped to a vertex of the buffer. This is indicated at block 306. Subsequently, it is determined whether or not all input texture coordinates have been mapped to the buffer vertices. This is indicated at block 307. If all input coordinates have not been mapped, then the mapping process returns to the step indicated at block 306 and this loop continues until all texture coordinates have been mapped to a buffer vertex.

As indicated at block 308, once all texture coordinates have been mapped to a buffer vertex, it is determined whether or not any of the buffer vertices have multiple texture coordinates mapped thereto. If it is determined that there is only a single set of texture coordinates for a vertex in question, then this data is directed to a processing unit, such as a GPU, which will configure the buffer data into the proper format for the desired output. This is indicated at block 309. If, however, it is determined that a particular vertex has multiple texture coordinates mapped thereto (from plurality of input regions), then these texture coordinates are directed to the processing unit where the plurality of texture coordinates are blended through a pixel shader function, that is, a function that processes input texture pixels so as to render the output pixels. Pixel shader functionality is known to those of ordinary skill in the art and, accordingly, is not further described herein.

Subsequently, a blended texture, or single set of data, is directed to the output, as indicated at block 311.

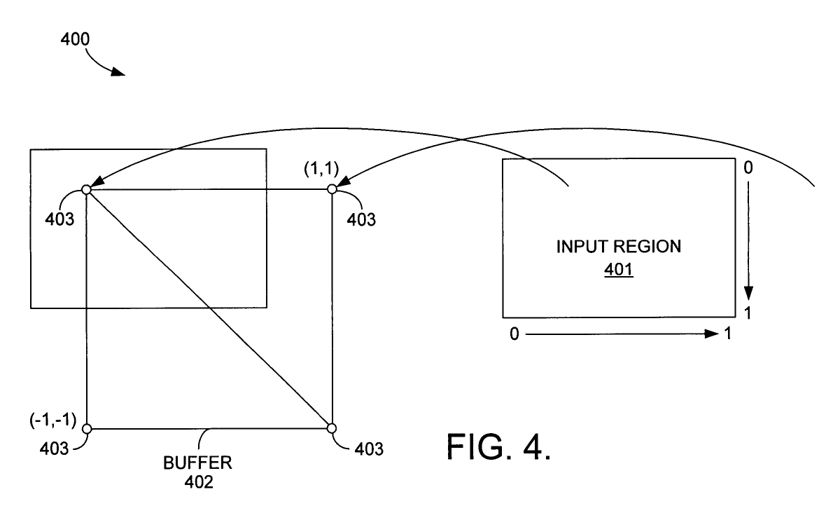

Various embodiments of the present invention depend upon the quantity of input regions and the configuration of the buffer corresponding thereto. For instance, exemplary buffer configurations are shown in the schematic diagrams of FIGS. 4-6, each of which is described in further detail below. The simplest of these exemplary embodiments is shown in the schematic diagram of FIG. 4, and is designated generally as buffer configuration 400. The buffer configuration 400 includes a single input region 401 and a buffer 402 comprised of a single quadrilateral, which is bisected to include two triangles. Note that if desired, the buffer may be further divided to include more than two triangles. In the illustrated embodiment, the buffer 402 has four vertices 403.

Note that input region 401 is shown twice in FIG. 4. In a first instance (the instance shown on the left side of the diagram), the input region 401 is shown overlapped by the buffer 402. This indicates that only a portion of the input region 401 is to be mapped to the buffer, that is, that portion which is included in the overlapping region. In a second instance (the instance shown on the right side of the diagram), the input region 401 is shown with arrows originating therefrom and being directed to the buffer 402 This indicates the area of the input region 401 that is being mapped to each vertex of the buffer 402

As previously stated, the input region 401 comprises a texture and a plurality of texture coordinates. The texture coordinates for an input region, including single input region 401, comprise a u coordinate and a v coordinate, with each of the u and v coordinates ranging between 0 and +1. For a single input region 401, only the texture coordinates contained within buffer 402 are mapped to coordinates of the buffer. However, the buffer coordinates have a different coordinate system than the input region coordinates. An x coordinate and a y coordinate correspond to each vertex 403 of the buffer 402, with each of the x and y coordinates typically ranging between −1 and +1. It should be noted that on occasion the −1 to +1 range may be extended to consider input pixels slightly beyond these outer limits in order to properly render the inputs at these outer limits. For example, if it is desired to blur an image, it is generally necessary to compute the average value of neighboring pixels. For pixels at the edge of the output, it is generally necessary to include input pixels slightly beyond the outer limits so as to accurately blur the edge pixels. Therefore, in order to map the u and v texture coordinates of the single input region 401 to the buffer 402, the u and v coordinates are transformed to x and y coordinates for the buffer such that Vertex i=xᵢ, yᵢ, zᵢ, uᵢ₁, vᵢ₁ where i equals the vertex number, and xᵢ, yᵢ, zᵢ are the vertex coordinates of Vertex i in the buffer. For a single input region 401, uᵢ₁, and vᵢ₁ correspond to the texture coordinates for the single input image. Where only u and v coordinates are present, i.e., in a two-dimensional image, uᵢ₁, and vᵢ₁ map only to x and y, respectively, such that zᵢ is not used.

The general mapping of the input region 401 to the vertices 403 of the buffer 402 is shown in FIG. 4. For buffer vertices outside of the input region 401, the texture coordinates can be obtained and mapped through a variety of processes including extrapolation, mirroring, and clamping. In cases where extrapolation is necessary, the resulting texture coordinates may go beyond the range of 0 to 1. For buffer vertices inside of the input region 401, the texture coordinates can be obtained and mapped through interpolation. Each of these processes is known to those of ordinary skill in the art and, accordingly, is not further described herein. If the processing unit is capable of such techniques, then these processes can be done in a vertex shader. Vertex shaders are known to those of ordinary skill in the art and, accordingly, are not further described herein.

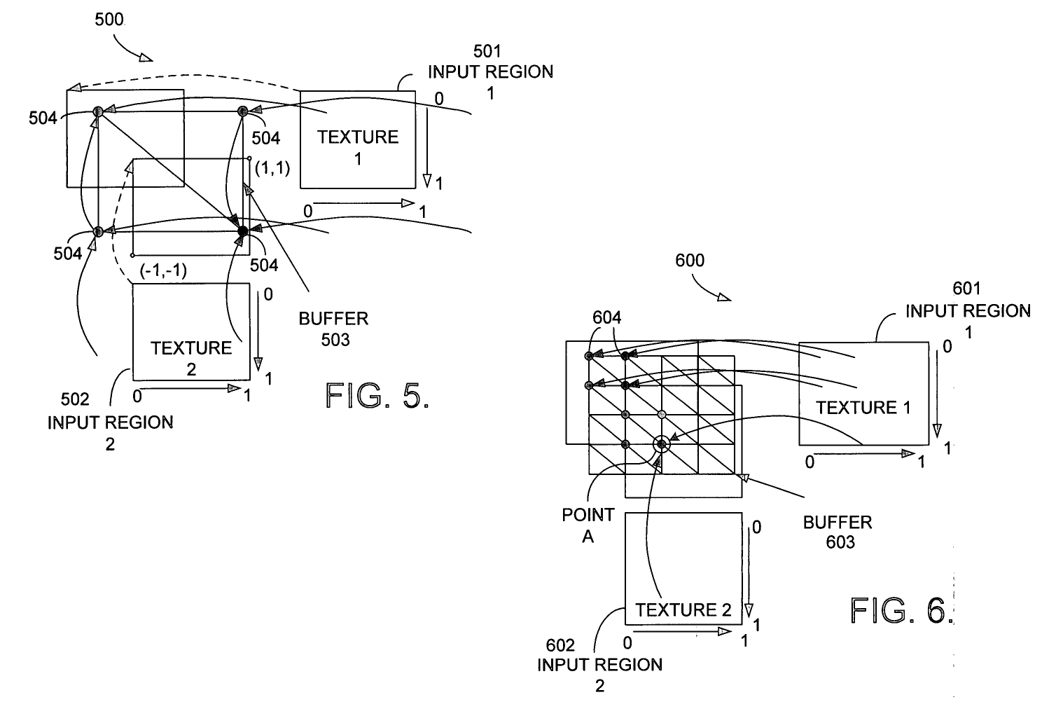

Another exemplary buffer configuration 500 which is shown in FIG. 5, takes the single input, single quadrilateral buffer, as previously described, and increases the number of inputs. In this embodiment, a plurality of input regions 501, 502 and a buffer 503 having a single quadrilateral are illustrated. As with the previous embodiment, the input regions 501, 502 are shown both overlapping with the buffer 503 and separate therefrom. The quadrilateral is bisected to include two triangles and the buffer 503 has four vertices 504. As with the embodiment illustrated in FIG. 4, the input regions 501, 502 each comprise a texture and a plurality of texture coordinates. The texture coordinates for each of the input regions 501, 502 each comprise a u coordinate and a v coordinate, with each of the u and v coordinates ranging between 0 and +1. For the plurality of input regions 501, 502, only the texture coordinates contained within the buffer 503 are mapped thereto. However, an x coordinate and a y coordinate corresponds to each vertex 504 of the buffer 503, with each x and y coordinate typically ranging between −1 and +1. However, as previously mentioned, on occasion the −1 to +1 range may be extended to consider inputs slightly beyond these outer limits in order to properly render the inputs at these outer limits.

Furthermore, depending on the size of the input regions 501, 502 and the size of the buffer 503, it is possible for input regions 501, 502 to overlap with one another, as shown in FIG. 5. Where this overlap occurs, there are overlapping textures from each input region 501, 502 that must be resolved. It is possible then that the coordinates for one or more vertices 504 in an overlapping region will have corresponding texture coordinates from each of a plurality of input regions 501, 502. That is, it is possible to have multiple u and v coordinates that must be bound to single x and y coordinates. Therefore, in order to map the texture coordinates u and v of the plurality of input regions 501, 502 to the buffer 503, the u and v coordinates are transformed to x and y coordinates for the buffer such that Vertex i=xᵢ, yᵢ, zᵢ, uᵢ₁ , vᵢ₁, uᵢ₂, vᵢ₂ where i equals the vertex number. Furthermore, xᵢ, yᵢ, zᵢ are the vertex coordinates of vertex i, and for multiple inputs to a single vertex, uᵢ₁, vᵢ₁, uᵢ₂, vᵢ₂ correspond to texture coordinates u and v for input regions 1 (reference numeral 501) and 2 (reference numeral 502), respectively. Where only u and v coordinates are present, as in a two dimensional image, they will map to their respective x and y coordinates with zi not being used. It is important to note that the transformation of input u and v coordinates into proper format (Vertex i=xᵢ, yᵢ, zᵢ, uᵢ₁, vᵢ₁, uᵢ₂, vᵢ₂ where i equals the vertex number) for the buffer utilizes the same format regardless of whether there is a single input or multiple inputs.

As with the buffer configuration illustrated in FIG. 4, a general mapping of the vertices 504 is shown in FIG. 5. For vertices outside of either of the input regions 501, 502, the texture coordinates can be obtained and mapped through a variety of processes including extrapolation, mirroring, and clamping. For buffer vertices inside of the input regions 501, 502, the texture coordinates can be obtained and mapped through interpolation. If the processing unit is capable of such techniques, then these processes can be done in a vertex shader.

While the buffer configurations 400 and 500 of FIGS. 4 and 5, respectively, illustrate alignment of input textures to an output region, they do so with a relatively basic buffer configuration. While relatively simple, inexpensive, and quick, such a basic buffer configuration has a fairly low resolution. Therefore, if it is desirable to render at least one input with increased resolution, a buffer configuration comprising multiple quadrilaterals may be employed. An exemplary multiple quadrilateral buffer configuration 600, which is shown in FIG. 6, comprises a plurality of input regions 601, 602 and a buffer 603 including a plurality of quadrilaterals. Furthermore, each of the plurality of quadrilaterals is bisected to include two triangles. Note that if desired, the buffer 603 may be further divided to include more than two triangles.

For the exemplary buffer configuration 600, the quadrilaterals of the buffer 603 are positioned such that each of the quadrilaterals is either entirely inside or outside of the plurality of input regions 601, 602. As a result of the plurality of quadrilaterals, the buffer 603 has a plurality of vertices 604, with the quantity of vertices 604 being a function of the quantity of quadrilaterals.

As stated previously, each input region 601, 602 comprises a texture and a plurality of texture coordinates. The texture coordinates for each input region 601, 602 comprise a u coordinate and a v coordinate, with each of the u and v coordinates ranging between 0 and +1. For a plurality of input regions 601, 602, only the texture coordinates contained within the buffer 603 are mapped thereto. However, an x coordinate and a y coordinate correspond to each vertex 604 of the buffer 603, with each of the x and y coordinates typically ranging between −1 and +1. Again, as previously mentioned, on occasion the −1 to +1 range may be extended to consider input pixels slightly beyond these outer limits in order to properly render the inputs at these outer limits.

Furthermore, depending on the size of the input regions 601, 602 and the size of buffer 663, it is possible for the input regions 601, 602 to overlap, as shown in FIG. 6. Where this overlap occurs, there are overlapping textures that must be resolved. As previously described, it is therefore possible that the coordinates for each vertex 604 in an overlapping region will have corresponding texture coordinates from a plurality of inputs 601, 602, that is, will have multiple u and v coordinates that must be bound to a single x and y coordinate. This is the case for the input regions 601, 602 and buffer 603 shown in FIG. 6.

Take, for example, the vertex labeled Point A in FIG. 6. This vertex has texture coordinates associated with both input region 1 (reference numeral 601) and input region 2 (reference numeral 602), as shown by the arrows directed thereto in FIG. 6. Therefore, in order to map the texture coordinates u and v of input regions 1 and 2 corresponding to Point A, the u and v coordinates are transformed to x and y coordinates as previously described, such that the buffer data corresponding to Point A will read Vertex A: x_{A}, y_{A}, z_{A}, u_{A1}, v_{A1}, u_{A2}, v_{A2} corresponding to the texture coordinates of both input regions 1 and 2 coinciding at Point A.

A general mapping of the vertices 604 is shown in FIG. 6. For vertices outside of the input regions 601, 602, the texture coordinates can be obtained and mapped through a variety of processes including extrapolation, mirroring, and clamping. For buffer vertices inside of the input regions 601,602, the texture coordinates can be obtained and mapped through interpolation. If the processing unit is capable of such techniques, then these processes can be done in a vertex shader.

Note that in each of the exemplary buffer configurations illustrated in FIGS. 4-6, the texture coordinates are transformed from at least one input region to the buffer for an output region. This method of transformation comprises providing the texture coordinates in u, v coordinate format (with each of the u and v coordinates ranging between 0 and 1) and providing x, y buffer coordinates (with each of the x and y coordinates typically ranging between −1 and +1) and mapping the texture coordinates to the buffer coordinates for each vertex. This mapping follows the general format of Vertex i=xᵢ, yᵢ, zᵢ, uᵢ₁, vᵢ₁, uᵢ₂, Vᵢ₂ where i equals the vertex number. Furthermore, xᵢ, yᵢ, zᵢ are the vertex coordinates of vertex i, and for multiple inputs to a single vertex, uᵢ₁, vᵢ₁, uᵢ₂, vᵢ₂ correspond to texture coordinates u and v for input regions 1 and 2, respectively. Therefore, for a plurality of vertices in a buffer, the buffer data structure resembles the format shown in Table 1 with each vertex number and individual coordinates being individual fields of data.

TABLE 1

Vertex 1: x₁, y₁, z₁, u₁₁, v₁₁, u₁₂, v₁₂, . . .
Vertex 2: x₂, y₂, z₂, u₂₁, v₂₁, u₂₂, v₂₂, . . .
Vertex 3: x₃, y₃, z₃, u₃₁, v₃₁, u₃₂, v₃₂, . . .
Vertex 4: x₄, y₄, z₄, u₄₁, v₄₁, u₄₂, v₄₂, . . .
Vertex 5: x₅, y₅, z₅, u₅₁, v₅₁, u₅₂, v₅₂, . . .
Vertex 6: x₆, y₆, z₆, u₆₁, v₆₁, u₆₂, v₆₂, . . .

Although two input regions are used as an example in FIG. 6 and six input regions are shown in Table 1, the invention is not limited to either of these input quantities. For instance, in one embodiment, the buffer configuration may accommodate between zero and eight inputs. The described processes are applicable to any size buffer density and corresponding number of quadrilaterals and associated vertices.

In one embodiment, a scenario can occur in which the input region is larger or smaller than the desired output region and the input must be scaled appropriately. In this situation, a buffer having a plurality of vertices is established to represent the desired output. In this embodiment, a vertex shader in the GPU calculates the required texture coordinate offsets and scaling such that the input is sized appropriately in the buffer for the desired output. Stated differently, the texture mapping computations mentioned above can be done in the GPU if it supports vertex shader. In that case, the rectangular area of each input region/output region, or alternatively the coefficients of coordinate transformation (scale and offset=translation), may be provided to the GPU. Subsequently, the actual calculations may be done in the vertex shader.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method in image processing for aligning a texture from at least one input region to an output region, the method comprising:
receiving information pertaining to the at least one input region, the information including a texture and corresponding texture coordinates;
receiving information pertaining to the output region;
utilizing the information pertaining to the input region and the information pertaining to the output region to create a buffer, the buffer having a plurality of vertices; and
mapping each of the texture coordinates of the input region to a vertex of the buffer.

2. The method of claim 1, wherein receiving information pertaining to the at least one input region comprises receiving information pertaining to each of a plurality of input regions, the information including a texture and corresponding texture coordinates; and wherein mapping each of the texture coordinates of the input region to a vertex of the buffer comprises mapping each of the texture coordinates of each of the plurality of input regions to a vertex the buffer.

3. The method of claim 2, further comprising:
directing information derived from the buffer to a processing unit; and
blending the texture coordinates for each vertex of the buffer having a plurality of texture coordinates mapped thereto utilizing the processing unit.

4. The method of claim 1, wherein utilizing the information pertaining to the input region and the information pertaining to the output region to create a buffer comprises utilizing the information pertaining to the input and output regions to create a buffer comprised of a single quadrilateral.

5. The method of claim 1, wherein receiving information pertaining to the output region comprises receiving information pertaining to the output region which includes a boundary encompassing the at least one input region and the buffer.

6. The method of claim 1, wherein utilizing the information pertaining to the input region and the information pertaining to the output region to create a buffer comprises utilizing the information pertaining to the input and output regions to create a buffer comprised of a plurality of quadrilaterals.

7. The method of claim 6, wherein utilizing the information pertaining to the input and output regions to create a buffer comprised of a plurality of quadrilaterals comprises utilizing the information pertaining to the input and output regions to create a buffer comprised of a plurality of quadrilaterals each of which is either entirely inside or outside of the input region.

8. The method of claim 1, wherein the texture coordinates of the at least one input region include a u coordinate and a v coordinate, each of the u and v coordinates ranging between 0 and +1.

9. The method of claim 8, wherein each of the buffer vertices includes an x coordinate and a y coordinate, each of the x and y coordinates ranging between −1 and +1, and wherein each u coordinate and v coordinate of the texture coordinates correlates to an x coordinate and y coordinate, respectively, of a buffer vertex.

10. One or more computer readable media having computer usable instructions embedded therein for performing the method of claim 1.

11. A system in image processing for aligning a texture from an input region to an output region, the system comprising:
an input receiving component for receiving at least one input region, the at least one input region having a texture and corresponding texture coordinates;
an output receiving component for receiving an output region; and
a buffer creating component for creating a buffer having a plurality of vertices each of which is capable of having the texture coordinates of the at least one input region mapped thereto.

12. The system of claim 11, wherein the at least one input region comprises a plurality of input regions each having a texture and corresponding texture coordinates, and wherein the texture coordinates of each of the plurality of input regions is capable of being mapped to the buffer.

13. The system of claim 12, further comprising:
a directing component for directing the buffer to a processing unit; and
a blending component for blending the texture coordinates for each vertex of the buffer having a plurality of texture coordinates mapped thereto utilizing the processing unit.

14. The system of claim 11, wherein the buffer comprises a single quadrilateral.

15. The system of claim 11, wherein the output region has a boundary which encompasses the at least one input region and the buffer.

16. The system of claim 11, wherein the buffer comprises a plurality of quadrilaterals.

17. The system of claim 16, wherein each of the plurality of quadrilaterals is either entirely inside or outside of said input region.

18. The system of claim 11, wherein the texture coordinates of the at least one input region include a u coordinate and a v coordinate, each of the u and v coordinates ranging between 0 and +1.

19. The system of claim 18, wherein each of the buffer vertices includes an x coordinate and a y coordinate, each of the x and y coordinates ranging between −1 and +1, and wherein each u coordinate and v coordinate of the texture coordinates correlates to an x coordinate and y coordinate, respectively, of a buffer vertex.

20. A method in image processing for translating texture coordinates from at least one input region to a buffer associated with an output region for the purpose of aligning textures, the method comprising:
providing at least one set of u and v texture coordinates, each coordinate ranging between 0 and +1;
providing at least one set of x and y buffer coordinates, each coordinate ranging between −1 and +1, wherein the at least one set of buffer coordinates is associated with a vertex (Vᵢ) of the buffer; and
mapping the at least one set of texture coordinates to the at least one set of buffer coordinates for the vertex (Vᵢ) as xᵢ, yᵢ, uᵢ, vᵢ.
